(19) United States
(12) Patent Application Publication
(10) Pub. No.: US 2002/0135795 A1
(43) Pub. Date: Sep. 26, 2002

(54) Method and apparatus for printing photographs from digital images

(76) Inventors: Hoi-Sing Kwok, Clear Water Bay (HK); Ho-Chi Huang, Clear Water Bay (HK)

Correspondence Address: BURNS DOANE SWECKER & MATHIS L L P, POST OFFICE BOX 1404, ALEXANDRIA, VA, 22313-1404, US

(21) Appl. No.: 09/814,219

(22) Filed: Mar. 22, 2001

(51) Int. Cl. B41J 1/00; G06F 15/00

(52) U.S. Cl. 358/1.15

(57) ABSTRACT

To produce a print from digital image data, the image data is used to generate a display of the image on a display device, such as a reflective LCD, a digital mirror, or a TFT active matrix LCD. The displayed image is separately exposed to each of red, green and blue light, which is preferably polarized. The exposed image is projected onto photosensitive paper or film, and the duration of the exposure is controlled during projection.

### FIELD OF THE INVENTION

This invention relates to a method and apparatus for printing hard copy photographs from digital images.

### BACKGROUND OF THE INVENTION

Traditional photography is an analogue process that involves the exposure and development of a photographic film. In all the process steps an analogue image is handled, from first exposure of the photographic film to development and printing of the film. Such traditional photography is capable of producing high-quality and high-resolution images.

More recently, however, digital techniques have become increasingly popular and digital cameras are being used to take photographs that may then be stored, processed and viewed by means of a computer. In addition to digital images produced by digital cameras, increasingly digital images may be produced directly by computer. While digital photography has many advantages over traditional photography, one major disadvantage is the difficulty of producing high-quality hard-copy images. Conventional colour printers have limited resolution and half-toning capabilities. Furthermore, attempts to improve half-toning properties of printers are normally at the price of loss of resolution. Therefore there remains the need to provide a way of printing high-quality hard-copy photographs from digitally stored images.

### PRIOR ART

Known methods of printing photographs from digital images include projecting the image onto photographic paper which may then be developed conventionally. There are many types of projectors that can take computer data or digital images and project them onto a screen, commonly known projectors include transmissive type thin film transistor (TFT) based active matrix liquid crystal display (AMLCD), micro-mirror based digital light processors (DLP), and crystalline silicon based liquid crystal on silicon (LCOS) microdisplays. U.S. Pat. No. 5,140,428, for example, describes using a TFT projector in conjunction with a video printer to produce either slide shows or video pictures on a screen. Also known from the prior art is U.S. Pat. No. 5,594,525 in which images are projected via an optical system onto light-sensitive paper.

The problem with many projectors, such as TFT AMLCD, is that the aperture ratio is small, in particular is usually less than 70% for 800×600 resolution displays. Furthermore the aperture ratio decreases further as the resolution of the image increases. The result is irritating lines on the image called pixelation. Such pixelation can easily be seen on the projected image or screen and is annoying.

### SUMMARY OF THE INVENTION

According to the present invention there is provided apparatus for producing a print from a digital image, comprising:

(a) a display device for generating an image from digital image data,

(b) means for exposing said image separately to red, green and blue light,

(c) optical projection means for projecting said exposed image onto photosensitive paper or film, and

(d) means for controlling the duration and sequence of the exposure of said image to red, green and blue light.

In a first embodiment of the invention the display device is a reflective liquid crystal on silicon microdisplay. Alternatively the display device is a digital mirror display device comprising micro-machined mirrors on silicon. In this embodiment red, green and blue light is polarised prior to exposing said image, and the display device reflects said red, green and blue light with a rotated polarization from pixels that are in an on condition.

In an alternative embodiment the display device is a monochrome transmissive thin film transistor active matrix liquid crystal display. In this embodiment the red, green and blue light is polarised prior to exposing the image, and the display device transmits the red, green and blue light with a rotated polarization from pixels that are in an on condition.

In both embodiments there may be provided separate sources of red, green and blue light, the operation of the separate sources of red, green and blue light being controlled by the control means, or there may be a single source of light and red, green and blue filters to generate the red, green and blue light, the operation of the filters being controlled by the control means. A particular advantage of the present invention is that by projecting red, blue and green light onto the display device, the display device itself may be monochrome. This is especially useful for transmissive TFT AMLCDs because a monochrome TFT AMLCD may have increased resolution and aperture ratio in comparison with a TFT AMLCD provided with colour filters as is conventional.

The control means may comprise a computer.

According to one aspect of the present invention there is provided apparatus for producing a print from a digital image, comprising:

(a) a light source,

(b) means for generating a collimated light beam from said source,

(c) a cold mirror for reflecting light of a wavelength shorter than a predetermined cut-off wavelength,

(d) a UV filter for transmitting light of a wavelength longer than a second predetermined cut-off wavelength,

(e) colour filter means for selectively passing red, green or blue light,

(f) a reflective display device for displaying a digitally generated image,

(g) a polarising beam splitter for directing polarised red, green or blue light onto said display device, and for allowing transmission of red, green or blue light reflected from on pixels of said display device,

(h) means for projecting said reflected light onto a photosensitive film or paper, and

(i) control means for controlling the operation of said apparatus.

According to another aspect of the present invention there is provided apparatus for producing a print from a digital image, comprising:

(a) a light source,

(b) means for generating a collimated light beam from said source,

(c) a cold mirror for reflecting light of a wavelength shorter than a predetermined cut-off wavelength,

(d) a UV filter for transmitting light of a wavelength longer than a second predetermined cut-off wavelength,

(e) colour filter means for selectively passing red, green or blue light,

(f) a transmissive display device for displaying a digitally generated image,

(g) a first polariser for directing polarised red, green or blue light onto said display device,

(h) a second polariser for allowing transmission of red, green or blue light transmitted through on pixels of said display device,

(i) means for projecting said reflected light onto a photosensitive film or paper, and

(j) control means for controlling the operation of said apparatus.

### BRIEF DESCRIPTION OF THE DRAWINGS

Two embodiments of the invention will now be described by way of example and with reference to the accompanying drawings, in which:

FIG. 1 is a schematic view of a first embodiment of the invention, and

FIG. 2 is a schematic view of a second embodiment of the invention.

### DETAILED DESCRIPTION OF PREFERRED EMBODIMENTS

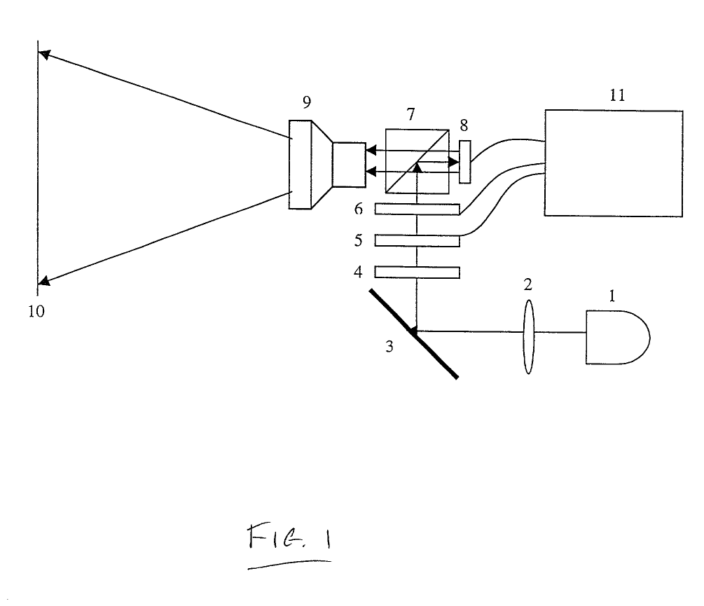

FIG. 1 shows one possible embodiment of the present invention. A light source 1 is collimated by a lens or lens combination 2 so as to be parallel. This light beam is then reflected by a cold mirror 3 which reflects only visible light with a wavelength below 700 nm. The light beam is further rid of harmful ultra-violet radiation by using a UV cutoff filter 4, which passes only light with wavelength above 440 nm. Thus only visible radiation between 440 nm and 700 nm will be used for the rest of the system.

This beam of visible light is sent through a shutter 5, which allows light to pass through for a controlled time duration. This control is effected by a central control means which may be a personal computer 11. The light is then sent through a color filter 6. This color filter passes light either in the red (580-650 nm), or green (510-580 nm), or blue (440-510 nm) regions of the spectrum. The color that can be passed is controlled electronically by the central control means 11 as well. This color filter can be made several ways. One possibility is to use a rotating color wheel with three color filters attached to it. The position of the wheel may be controlled by the control means 11. Instead of using filters to provide the red, green and blue light from a white light source, instead separate red, green and blue light sources (such as light emitting diodes for example) may be used to provide red, green and blue light in sequence. When such colour-specific sources are used, it will be understood that the UV filter and the cold mirror become unecessary.

In this first embodiment, the collimated filtered and shuttered visible light is sent to a polarizing beam splitter (PBS) 7. This PBS reflects only one polarization of light and passes light with the opposite polarization. The reflected polarized light impinges on a reflective display device 8. The function of the display device 8 is to act as a light valve to modulate the polarization state of the incoming light. The light valve 8 consists of many pixels to form a display. If a particular pixel is on, the polarization of light reflected from that pixel will be rotated by 90°. Otherwise the polarization is unchanged. The control means 11 is used to drive the light valve to form any pictures from a digital source such as a digital picture or a computer generated image, with grayscales and contrast ratios that are appropriate for making good quality pictures. For the on-pixels of the light valve 8, the reflected light will be passed by the PBS 7, and projected onto a screen 10 by a projection lens 9.

In this embodiment of the invention, the screen is actually a photosensitive paper or film. The light impinging on it will expose the photograph. In an actual operation, the light shutter 5 and color filter 6 will work synchronously so that red, green and blue colors will be passed through and used to expose the photosensitive paper 10, one color at a time. The degree of exposure of each color, thus the color mixture of the final picture, can be controlled by the control means 11.

It will be understood that the image displayed by the display device will differ when each of the three colours red, blue and green are projected onto the display device, so that when the three images are combined on the photosensitive paper are correct image will be formed. The control means 11 will control the projection of the different “red”, “green” and “blue” images.

In this embodiment, the reflective light valve display device 8 can be a silicon microdisplay, or may be a digital mirror display device comprising micromachined mirrors on silicon.

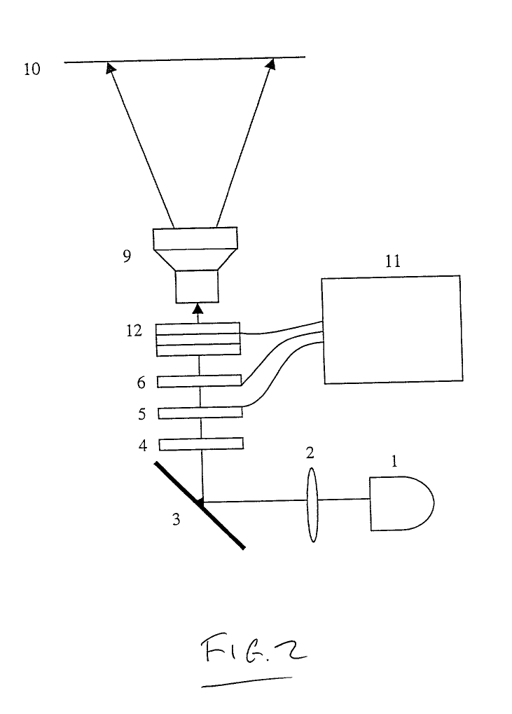

FIG. 2 shows another embodiment of the present invention. In this embodiment of the invention, the reflective display device light valve is replaced by a transmissive display device light valve 12. The optical system of light source 1, collimating lens 2, mirror 3, UV filter 4, light shutter 5, color filter 6 are essentially the same. The transmissive light valve 12 (which may be a transmissive TFT AMLCD display) consists of an input and output polarizers, and liquid crystal cell. It is also divided into many pixels that can be individually controlled by control means 11 to form any picture from a digital source, such as a picture taken by a digital camera or a computer-generated picture. The polarizer arrangement is also such that the on-pixels will transmit light and sent it to the projection lens 9. From the projection lens 9 the light is sent to a screen or photographic paper or film 10 to form a viewable or printable image. As in the first embodiment, instead of using colour filters to generate the red, green and blue light from a white light source, individual sources of red, green and blue light may be used instead, and if individual colour-specific sources are used then the UV filter and cold mirror will not be necessary.

In the embodiments described above, the red, green and blue light to be projected onto or through the display device may be formed either by passing white light selectively through colour filters, or directly from sources of coloured light (eg from light emitting diodes). The former approach has the advantage of high intensity, but may be physically quite large and bulky. Coloured light sources, on the other hand, may be more compact and lightweight, but weak in intensity.

As in the first embodiment of the invention, different images for red, green and blue light will be displayed in turn on the display device so that the resulting image is correctly formed.

1. Apparatus for producing a print from a digital image, comprising:
(a) a display device for generating an image from digital image data,
(b) means for exposing said image separately to red, green and blue light,
(c) optical projection means for projecting said exposed image onto photosensitive paper or film, and
(d) means for controlling the duration and sequence of the exposure of said image to red, green and blue light.

2. Apparatus as claimed in claim 1 wherein said display device is a reflective liquid crystal on silicon microdisplay.

3. Apparatus as claimed in claim 1 wherein said display device is a digital mirror display device comprising micro-machined mirrors on silicon.

4. Apparatus as claimed in claim 2 or 3 wherein said red, green and blue light is polarised prior to exposing said image, and said display device reflects said red, green and blue light with a rotated polarization from pixels that are in an on condition.

5. Apparatus as claimed in claim 1 wherein said display device is a transmissive thin film transistor active matrix liquid crystal display.

6. Apparatus as claimed in claim 5 wherein said red, green and blue light is polarised prior to exposing said image, and said display device transmits said red, green and blue light with a rotated polarization from pixels that are in an on condition.

7. Apparatus as claimed in claim 1 comprising separate sources of red, green and blue light, and wherein the operation of said separate sources of red, green and blue light is controlled by said control means.

8. Apparatus as claimed in claim 1 comprising a single source of light and further comprising red, green and blue filters to generate said red, green and blue light, wherein operation of said filters is controlled by said control means.

9. Apparatus as claimed in claim 1 wherein said control means comprises a computer.

10. Apparatus for producing a print from a digital image, comprising:
(a) a light source,
(b) means for generating a collimated light beam from said source,
(c) a cold mirror for reflecting light of a wavelength shorter than a predetermined cut-off wavelength,
(d) a UV filter for transmitting light of a wavelength longer than a second predetermined cut-off wavelength,
(e) colour filter means for selectively passing red, green or blue light,
(f) a reflective display device for displaying a digitally generated image,
(g) a polarising beam splitter for directing polarised red, green or blue light onto said display device, and for allowing transmission of red, green or blue light reflected from on pixels of said display device,
(h) means for projecting said reflected light onto a photosensitive film or paper, and
(i) control means for controlling the operation of said apparatus.

11. Apparatus for producing a print from a digital image, comprising:
(a) a light source,
(b) means for generating a collimated light beam from said source,
(c) a cold mirror for reflecting light of a wavelength shorter than a predetermined cut-off wavelength,
(d) a UV filter for transmitting light of a wavelength longer than a second predetermined cut-off wavelength,
(e) colour filter means for selectively passing red, green or blue light,
(f) a transmissive display device for displaying a digitally generated image,
(g) a first polariser for directing polarised red, green or blue light onto said display device,
(h) a second polariser for allowing transmission of red, green or blue light transmitted through on pixels of said display device,
(i) means for projecting said reflected light onto a photosensitive film or paper, and
(j) control means for controlling the operation of said apparatus.

12. Apparatus for producing a print from a digital image, comprising:
(a) sources of red, green and blue light,
(b) means for generating a collimated light beam from said sources,
(c) a reflective display device for displaying a digitally generated image,
(d) a polarising beam splitter for directing polarised red, green or blue light onto said display device, and for allowing transmission of red, green or blue light reflected from on pixels of said display device,
(e) means for projecting said reflected light onto a photosensitive film or paper, and
(f) control means for controlling the operation of said apparatus.

13. Apparatus for producing a print from a digital image, comprising:
(a) sources of red, green and blue light,
(b) means for generating a collimated light beam from said sources,
(c) a transmissive display device for displaying a digitally generated image,
(d) a first polariser for directing polarised red, green or blue light onto said display device,
(e) a second polariser for allowing transmission of red, green or blue light transmitted through on pixels of said display device,
(f) means for projecting said reflected light onto a photosensitive film or paper, and
(g) control means for controlling the operation of said apparatus.
